(19) United States
(12) Patent Application Publication
(10) Pub. No.: US 2015/0356576 A1
(43) Pub. Date: Dec. 10, 2015

(54) COMPUTERIZED SYSTEMS, PROCESSES, AND USER INTERFACES FOR TARGETED MARKETING ASSOCIATED WITH A POPULATION OF REAL-ESTATE ASSETS

(71) Applicants: Ashutosh Malaviya, San Jose, CA (US); Jason Hiver Tondu, Coeur d'Alene, ID (US); Aniruddha Banerjee, Albany, CA (US); Anita Narra, Pleasanton, CA (US); Yu Pan, La Crescenta, CA (US); Eric Fang, Albany, CA (US); Fan Jiang, San Jose, CA (US)

(72) Inventors: Ashutosh Malaviya, San Jose, CA (US); Jason Hiver Tondu, Coeur d'Alene, ID (US); Aniruddha Banerjee, Albany, CA (US); Anita Narra, Pleasanton, CA (US); Yu Pan, La Crescenta, CA (US); Eric Fang, Albany, CA (US); Fan Jiang, San Jose, CA (US)

(21) Appl. No.: 14/722,151

(22) Filed: May 27, 2015

Related U.S. Application Data
(63) Continuation of application No. 13/481,542, filed on May 25, 2012.
(60) Provisional application No. 61/490,928, filed on May 27, 2011.

(51) Int. Cl. G06Q 30/02

(52) U.S. Cl. CPC G06Q 30/0202; G06Q 50/16

(57) ABSTRACT

In one aspect, a method of generating a prediction list of real-estate assets that have a specified probability of being placed for sale within a specified period of time includes the step of providing a list of real-estate assets. Each real-estate asset is associated with one or more real-estate assets attributes. The method includes the step of providing a training data set wherein the training data set comprises a past population of data associated with a plurality of real-estate assets and a set of training-data set attributes for each real-estate asset in the plurality of real-estate assets. The method includes providing a testing data set wherein the testing data set comprises another past population of data associated with the plurality of real-estate assets and a set testing-data set attributes for each real-estate asset in the plurality of real-estate assets, wherein the set of testing data set attributes comprises an updated version of the training data set attributes from a specified later time.

### CLAIM OF PRIORITY

This application claims priority from U.S. application Ser. No. 13/481,542, titled Enhanced systems, processes, and user interfaces for targeted marketing associated with a population of assets and filed May 25, 2012. This application is hereby incorporated by reference in its entirety for all purposes. application Claims Priority to U.S. Provisional Application No. 61/490,928, entitled Targeting Based on Hybrid Clustering Techniques, Logistic Regression and Support Vector Machine Methods, filed 27 May 2011, to U.S. Provisional Application No. 61/490,934, entitled Clustering Based Home Price Index and Automated Valuation Model Utilizing the Neighborhood Home Price Index, filed 27 May 2011, and to U.S. Provisional Application No. 61/490,939, entitled Stochastic Utility Based Methodology for Scoring Real-Estate Assets Like Residential Properties and Markets, filed 27 May 2011, which are each incorporated herein in its entirety by this reference thereto.

### BACKGROUND

1. Field

This application relates generally to determining an ordered list or score based upon one or more data sets, and more specifically to a system, article of manufacture and method of targeted marketing associated with a population of real-estate assets.

2. Related Art

It is often difficult to predict the performance of sales and/or marketing over a large population, such as for one or more properties within a region. For example, in domestic real estate markets, wherein thousands of properties are commonly associated within each region, property values are typically determined on a case by case basis, with a search of comparable properties in a neighborhood that have sold recently. As well, agents for a particular area often send out advertising materials to a large percentage of addresses within their region, with little knowledge of the likelihood that a particular addressee would be interested in contacting them to sell or buy a home.

It would therefore be advantageous to provide a system and/or process that improves the efficiency of sales or marketing of such assets. Such a development would provide a significant technical advance.

In other markets, such as for but not limited to the sales of solar power equipment, at the present time it is typically only a small percentage of properties that have already installed solar power systems, and it is extremely difficult to determine which land owners in any region may likely be interested in pursuing the purchase and installation of such a system. Therefore, it is often costly and ineffective to contact a large percentage of land owners or addressees within a region, with little knowledge of the likelihood that a particular addressee would be interested in contacting them to purchase or install a solar power system.

It would therefore be advantageous to provide a system and/or process that improves the efficiency of sales or marketing of such equipment. Such a development would provide a significant technical advance.

### BRIEF SUMMARY OF THE INVENTION

In one aspect, a method of generating a prediction list of real-estate assets that have a specified probability of being placed for sale within a specified period of time includes the step of providing a list of real-estate assets. Each real-estate asset is associated with one or more real-estate assets attributes. The method includes the step of providing a training data set wherein the training data set comprises a past population of data associated with a plurality of real-estate assets and a set of training-data set attributes for each real-estate asset in the plurality of real-estate assets. The method includes providing a testing data set wherein the testing data set comprises another past population of data associated with the plurality of real-estate assets and a set testing-data set attributes for each real-estate asset in the plurality of real-estate assets, wherein the set of testing data set attributes comprises an updated version of the training data set attributes from a specified later time. The method includes implementing a backtest on the training data set to determine one or more first prediction models. The method includes generating a first prediction list using the one or more first prediction models. A first probability score for each real-estate asset in the list of real-estate assets to be placed for sale within a specified period of time is calculated using the one or more first prediction models. The method includes using the testing data set to determine a second prediction model from the one or more first prediction models based on the test data set by combining the one or more first prediction models. The method includes generating a second prediction list using the second prediction model, wherein a second probability score for each real-estate asset in the list of real-estate assets to be placed for sale within the specified period of time is calculated using the second prediction model. The method includes averaging the first probability score and the second probability score of each real-estate asset in the list of real-estate assets to generate an averaged probability score for each real-estate asset. The method includes ordering a prediction list comprising each real-estate asset ordered according for each real-estate asset's averaged probability score.

### BRIEF DESCRIPTION OF THE DRAWINGS

The present application can be best understood by reference to the following description taken in conjunction with the accompanying figures, in which like parts may be referred to by like numerals.

FIG. 1 illustrates an example process for generating a prediction model for prioritizing a list of real-estate assets, according to some embodiments.

FIG. 2 illustrates another example process for generating a prediction model for prioritizing a list of real-estate assets, according to some embodiments.

FIG. 3 illustrates an example process adjusting a ratio of a dataset, according to some embodiments.

FIG. 4 illustrates a process for implementing various embodiments herein, according to some embodiments.

FIG. 5 illustrates an example geographic data dictionary, according to some embodiments.

FIG. 6 illustrates an example geographic interaction data dictionary, according to some embodiments.

FIG. 7 illustrates an example demographic data dictionary, according to some embodiments.

FIG. 8 illustrates an example process of combination of ascendant strategy based on a sequential introduction of variables and stepwise ascending variable introduction strategy variable selection, according to some embodiments.

FIG. 9 illustrates an example process improving a prioritized a list of real-estate assets, according to some embodiments.

FIG. 10 is a block diagram of a sample computing environment that can be utilized to implement some embodiments.

FIG. 11 depicts an exemplary computing system that can be configured to perform any one of the processes provided herein.

The Figures described above are a representative set, and are not an exhaustive with respect to embodying the invention.

### DETAILED DESCRIPTION

Disclosed are a system, method, and article of manufacture of targeted marketing associated with a population of real-estate assets. The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the various embodiments.

Reference throughout this specification to “one embodiment,” “an embodiment,” “one example,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### DEFINITIONS

The following are example definitions that can be utilized to implement some embodiments.

Backtesting can refer to testing a predictive model using existing historic data. Backtesting is a kind of retrodiction, and a special type of cross-validation applied to time series data. Backtesting can be a way to do selection of covariates and check model predictive ability. A BacktestIM can be calculated according to the following equation: IM=5*(# of sold or listed on top20)/(total # of sold or listed).

Bootstrap aggregating (‘bagging’) can be a machine learning ensemble meta-algorithm designed to improve the stability and accuracy of machine learning algorithms used in statistical classification and regression.

Cluster analysis or clustering is the task of grouping a set of objects in such a way that objects in the same group (called a cluster) are more similar (in some sense or another) to each other than to those in other groups (e.g. clusters).

Data aggregator can be an organization involved in compiling information from detailed databases on individuals and providing that information to others.

Ensemble learning can use multiple learning algorithms to obtain better predictive performance than could be obtained from any of the constituent learning algorithms

Event rate a measure of how often a particular statistical event (such as those discussed infra) occurs within the experimental group (such as those discussed infra) of an experiment.

Fuzzy clustering is a class of algorithms for cluster analysis in which the allocation of data points to clusters is not “hard” (all-or-nothing) but “fuzzy” in the same sense as fuzzy logic.

Logistic regression can include, inter alia, measuring the relationship between the categorical dependent variable and one or more independent variables, which are usually (but not necessarily) continuous, by using probability scores as the predicted values of the dependent variable.

Mean squared error (MSE) of an estimator can measure the average of the squares of the “errors”, that is, the difference between the estimator and what is estimated.

OOB (out-of-bag) data can be used to measure performance of random forest, as well as get estimates of variable importance.

Random forest can be an ensemble learning method for classification, regression and other tasks, that operate by constructing a multitude of decision trees at training time and outputting the class that is the mode of the classes (e.g. classification) or mean prediction (e.g. regression) of the individual trees. Random forests can correct for decision trees' habit of overfitting to their training set. As an ensemble method, random Forest can combine one or more ‘weak’ machine-learning methods together. Random forest can be used in supervised learning (e.g. classification and regression), as well as unsupervised learning (e.g. clustering).

Real estate can be property consisting of land and the buildings on it, along with its natural resources such as crops, minerals, or water; immovable property of this nature; an interest vested in this; an item of real property; buildings or housing in general.

Real estate broker or real estate agent can be a person who acts as an intermediary between sellers and buyers of real estate/real property and attempts to find sellers who wish to sell and buyers who wish to buy. As used herein, a realtor can be a real estate broker, real estate agent and/or other similar real estate profession service provider.

Tract can geographic region defined for the purpose (e.g. taking a census, voting precinct, other governmental region, housing tract, subdivision of a housing tract, etc.).

Training set can be a set of data used in various areas of information science to discover potentially predictive relationships. Training sets can be used in artificial intelligence, machine learning, genetic programming, intelligent systems, and statistics. The training set data should not be confused of testing set data. Test data set can be a set of data used in various areas of information science to assess the strength and utility of a predictive relationship.

Exemplary Methods

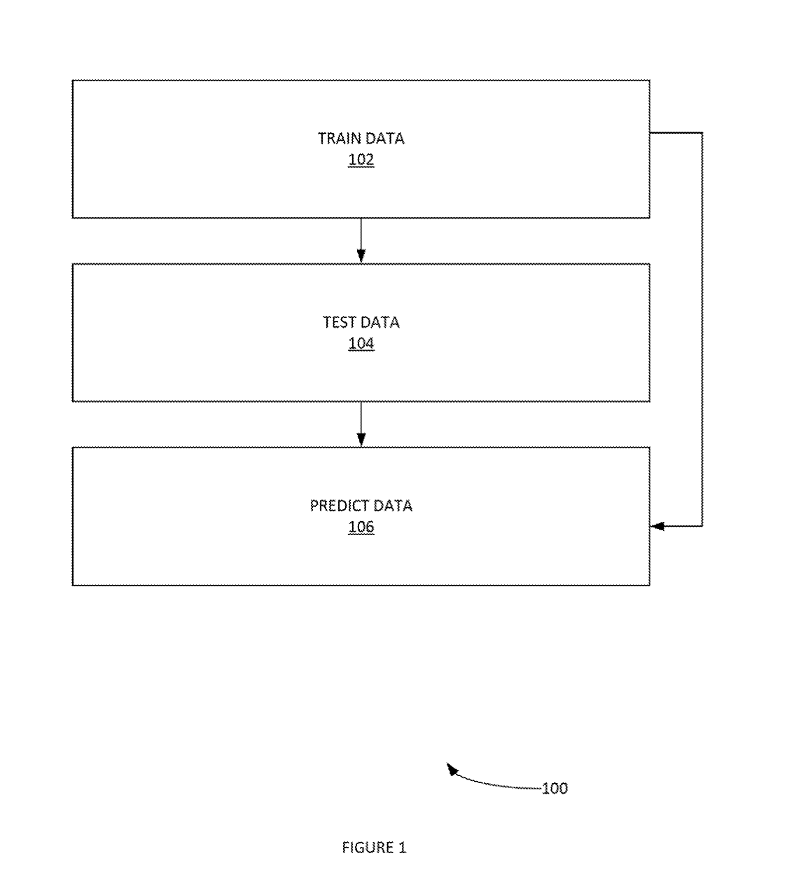

FIG. 1 illustrates an example process 100 for generating a prediction model for prioritizing a list of real-estate assets, according to some embodiments. Process 100 can prioritize a list of real-estate assets (e.g. residential homes, etc.) to assist real-estate agents to identify which residential home is more likely to be sold or listed in the following months. Process 100 can utilize various methods and systems provided in U.S. patent application Ser. No. 13/481,542, titled Enhanced systems, processes, and user interfaces for targeted marketing associated with a population of assets and filed on May 25, 2012. U.S. patent application Ser. No. 13/481,542 is hereby incorporated herein by reference. Process 100 can use property data (e.g. information about real-estate asset attributes, owner/resident demographic data, etc.) to build a random forest method. Process can combine the random forest method with logistic regression methods to develop the prioritized list of real-estate assets. The prioritized list of real-estate asset can be prioritized based on such factors as a highest probability to be placed on the market in a specified time period in a specified geographic region (e.g. a tract, a neighborhood, a school district, a municipality, etc.). Process 100 can optionally utilize fuzzy c means methods (e.g. fuzzy c-means clustering) in some embodiments.

During a backtest, a first training set of data (e.g. ‘TrainData(2 years ago)’ data set) can be used to predict a later obtained test data set (e.g. ‘TestData(1 year ago)’ data set). The training set of data and the test data set can be historical data sets of real-estate entity data and/or associate information (e.g. owner demographic data, etc.). This can be used to generate a model (e.g. a statistical model) and provide a BacktestIM. A BacktestIM can be calculated according to the following equation: IM=5*(# of sold or listed on top20)/(total # of sold or listed). In order to generate a prediction list (e.g. a list of residential homes or other real-estate assets and their respective probability for being put up for sale for a specified tract), a training set of data can be used to generate models. A testing dataset can then be used to tune weights to combine various models together. These combined models can then be used to predict probabilities for various market behaviors for specified real-estate entities (e.g. ‘will be put up for sale’, ‘will not be put up for sale’, etc.) within a specified probability threshold (e.g. as a ‘PredData(current market)’ dataset). At the same time, the same weights and same models can be applied on the on testing dataset to also generate models and predict a prediction data set. An average of these two results can be calculated to provide a probability to each property, and then prioritize the list of real-estate entities. Accordingly, in step 102 of process 100, one or more training data set operations can be implemented. Step 102 can be used to generate prediction models. In step 104, one or more testing data set operations can be implemented. Step 104 can also be used to generate prediction models. The prediction models of step 102 and step 104 can be combined (e.g. averaged) to predict the data in step 106.

In some cases some variables may have missing value, e.g. year_built, appr_since_last, beds, etc. We adopt technique to back-fill the population of data using estimated values.

Various methods can be used to deal with data outliers and data transformation issues. Some outliers can be easily detected, like year_built is 2020 year. Others outliers we detect them by applying (mean−3*sigma, mean+3*sigma) for each variables in the territory (tract). If the variables are out of range, a boundary value can be assigned to them. Examples of these variables can be, inter alia: year_built, sqft, sqftlot, etc. Outliers can be removed before performing a statistical method. For example, the following ranges can be used for specific variable outliers: set beds to [1,6], set year_built to [1600, curr_year]. An example data transformation process can include, inter alia: taking a log of (curr_year−year_built+1); log(sqft+1); log(current_hold_days+2) and log(price). These transformations can be aimed to meet the assumptions of a statistical test or procedure, and also can decrease the effects of certain outliers in certain in the specified variables.

Example logistic regression method(s) are now provided. In one example, thirteen (13) logistic regression models can be provided. Logistic regression model variables can be selected by forwarding selection based on AIC, odds ratio, and random forest methods. Example variables are provided in the following table.

| | |
|---|---|
| unitPrice= price/ sqft | appr_hold= |
| | appr_since_last/current_hold_days |
| unitSqft= sqft/ beds | apprPrice= appr_since_last * price |
| sqftPrice= price* sqft | yearPrice= year_built*price |
| yearSqft= year_built* sqft | ltvPrice= ltv_new * price |
| priceSquare= price * price | sqftHold= sqft* current_hold_days |

The thirteen logistic regression models are provided in the following table.

| | Response | Variables |
|---|---|---|
| 1 | sl_yn_nm | NOD+ ptype+ price+ sqft+ sales_hy10+current_hold_days |
| 2 | sl_yn_nm | NOD+ ptype+ price+ sqft+ sales_hy10+current_hold_days |
| 3 | sl_yn_nm | NOD+ ptype+ price+ sqft+ sales_hy10+current_hold_days |
| 4 | sl_yn_nm | NOD+ ptype+ price+ sqft+ sales_hy10+ I((current_hold_days)\hat{ }2) |
| 5 | sl_yn_nm | NOD+ ptype+ price+ ltv_new + current_hold_days + |
| | | I((current_hold_days)\hat{ }2) |
| 6 | sl_yn_nm | NOD+ ptype+ ltv_new + age_cat + current_hold_days + |
| | | appr_since_last+ I((appr_since_last)\hat{ }2) |
| 7 | sl_yn_nm | NOD+ ptype+ sales_hy10 + ltv_new + I((appr_since_last)\hat{ }2) |
| 8 | sl_yn_nm | NOD+ ptype+ ltv_new+ current_hold_days+ I((current_hold_days)\hat{ }2) + |
| | | appr_since_last+ beds+ beds:ltv_new |
| 9 | sl_yn_nm | NOD+ ptype+ price+ sqft+ ltv_new+ age_cat+ current_hold_days+ |
| | | I((appr_since_last)\hat{ }2) |
| 10 | sl_yn_nm | NOD+ ptype+ price+ I(price\hat{ }2)+ sqft+ appr_since_last+ current_hold_days+ |
| | | I((current_hold_days)\hat{ }2) + |

current_hold_days*appr_since_last+ltv_new+ I(ltv_new\hat{ }2)+ ltv_new*

current_hold_days+ year_built+ ltv_new*appr_since_last+

ltv_new*appr_since_last*current_hold_days

| | | |
|---|---|---|
| 11 | sl_yn_nm | appr_since_last*price+ sqft+ sqft*sqft+ price*price+ year_built*sqft+ |
| | | sqft*appr_since_last+year_built*price+ sqft*price+ |

price+ beds*price+ year_built*current_hold_days+

| | | |
|---|---|---|
| | | sqft*current_hold_days+current_hold_days*price |
| 12 | sl_yn_nm | price+ price* price+ year_built * appr_since_last + current_hold_days* |
| | | sales_hy10+ beds*appr_since_last +ltv_new+ beds*sqft + |

sqft*sales_hy10 + sqft+ beds*price+ year_built*sqft+

| | | |
|---|---|---|
| | | current_hold_days* |
| | | current_hold_days+current_hold_days*appr_since_last+ltv_new*ltv_new |
| 13 | sl_yn_nm | price* unitPrice + I(unitPrice\hat{ }2)+ year_built*unitPrice+ year_built* prices+ |
| | | appr_since_last*price + unitPrice *unitSqft |

Thirteen (13) different logistic regressions can be generated with the thirteen (13) different datasets from TrainData. These can then be applied as models on TestData. The top two (2) champion models with the top two (2) BacktestIM scores can be selected.

Example ‘regular’ random forest method(s) are now provided. In one example, two (2) different datasets can be used to build a random forest. These are provided in the following table:

| Dataset | Variables |
|---|---|
| Data1 | “sqft”, “apprPrice”, “yearSqft”, “sqftPrice”, “priceSquare”, |
| | “yearPrice”, “ltvPrice”, “sqftHold” |
| Data2 | “NOD”, “beds”, “ptype”, “year_built”, “sqft”, |
| | “current_hold_days”, “appr_since_last”, “price”, |
| | “sales_hy10”, “ltv_new” |

Dataset ‘Data 1’ variables can be selected combination of ascendant strategy based on a sequential introduction of variables and stepwise ascending variable introduction strategy. ‘Data 2’ variables can include all possible variables without any interaction. Those two models can use the default m=sqft(#features) and/or mtry=200. Two models can be generated from the training data set and applied to the testing data set. Those two models can use the default m=sqft(#features) and mtry=200. ‘m’ can be the number of random features selected each time to generate models. ‘mtry’ can be how many decision trees are used build to form a random forest. The best BacktestIM and corresponding model can be selected as a champion model from regular random forest.

Example balanced random forest method(s) are now provided. Random forest models can use down-sampling without data loss. Random forest models can use down-sampling when classification class is extremely unbalanced. Recall that random forest a tree ensemble method. A large number of bootstrap samples can be obtained from the training data set and a separate unpruned tree can be created for each data set. This model can contain another feature that randomly samples a subset of predictors at each split to encourage diversity of the resulting trees. When predicting a new sample, a prediction can be produced by every tree in the forest. These results can be combined to generate a single prediction for an individual sample. Random forests (and/or other bagging methods) can use bootstrap sampling. For example, if there are ‘n’ training data set instances, the resulting sample can select ‘n’ samples with replacement. As a consequence, some training data set samples can be selected more than once. It is noted that three sets of data can be utilized in three different time frames: training, testing and prediction. Training data set: which has the snapshot of variables including but not limited to: sqft, appr_since_last, year_built, 1tv, sales_hy10, price, current_hold_days, NOD, ptype from 2 years ago. The response variable can be whether the house got listed or sold in the following one year period. In one example, the testing data set can be a snapshot of the same variables from one (1) year before the operation is run. The response variable can be whether the house was listed or sold in the following one year period. The prediction data set can be the current snapshot of the same variables. The prediction data set may not have a response variable.

To incorporate down-sampling, random forest can take a random sample of sizec*nmin, where ‘c’ is the number of classes and ‘nmin’ is the number of samples in the minority class. In one example, the date can be set as Mar. 24, 2015. The training dataset can include the market data from Mar. 1, 2013-Mar. 1 2014. Features/attributes include can be, inter alia: sqft, appr_since_last, year_built, 1tv, sales_hy10, price, current_hold_days, NOD, ptype. The response variable can be whether the real-estate asset sold and/or was listed during this time period. The testing dataset can be market data for Mar. 1, 2014-Mar. 1 2015. The features/attributes can be the same as the training data. The response variable can be whether the real-estate asset sold and/or was listed (but not include listed in the training period but not sold in the testing period). The predicting dataset can include current market data for Mar. 1, 2015. The features/attributes can be the same as training data, but variables' values are snapshot at first day of table period. For example, some basic variables' values can be the same as the training data, e.g. beds, sqft. But some other time-varying variables, like 1tv, current_hold_days, are calculated by table period. No response variables are required for the predicting dataset. For client prediction performance calculation, the real-estate assets will not be counted as sold and/or listed if they were already listed within one year before the client signed the contract. A balanced random forest can be applied by adapting a stratified bootstrap method. This can include sampling with replacement from within each class. For each iteration, a bootstrap sample can be drawn from a minority class. The same number or twice or three times or four times of cases can be randomly drawn with replacement from the majority classes.

In some examples, two different datasets can be used to build a random forest. These are provided in the following table:

| Dataset | Variables |
|---|---|
| Data1 | “sqft”, “apprPrice”, “yearSqft”, “sqftPrice”, “priceSquare”, |
| | “yearPrice”, “ltvPrice”, “sqftHold” |
| Data2 | “NOD”, “beds”, “ptype”, “year_built”, “sqft”, |
| | “current_hold_days”, “appr_since_last”, “price”, |
| | “sales_hy10”, “ltv_new” |

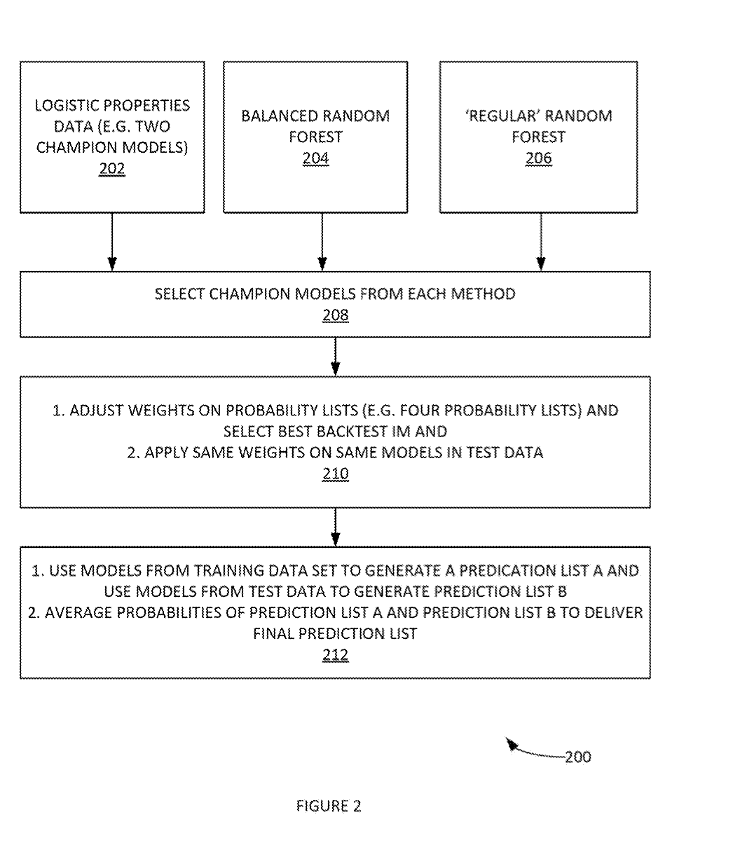

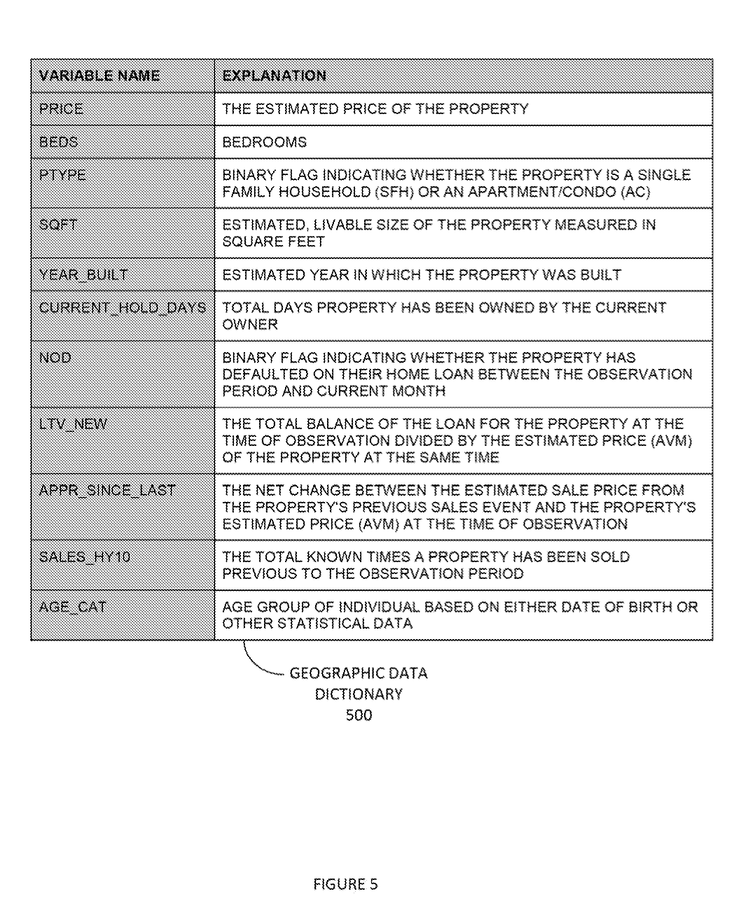

FIG. 2 illustrates another example process 200 for generating a prediction model for prioritizing a list of real-estate assets, according to some embodiments. Process 200 can utilize all or portions of process 100 provided supra. In step 202, logistic properties data operations can be performed and two champion models selected. In step 204, the balanced random forest operations can be performed. Different ratio can be attempted in order to balance data to generate models on training data. The champion model with a particular ratio based on BacktestIM can then be selected. In step 206, the ‘regular’ random forest operations can be performed. Steps 202-206 can be performed during the training phase of process 100 (e.g. during step 102). In step 208, the select champion models from each method of steps 202-206 can be selected. For example, the weights on probability lists (e.g. four probability lists) can be adjusted and the best BacktestIM can be selected. Additionally, these weights can be applied on the same models during the test data phase of process 100 (e.g. during step 104). In step 212, the models from training data set can be used to generate a predication list A. The models from test data can be used to generate prediction list B. The average probabilities of prediction list A and prediction list B can be combined to deliver a final prediction list. Step 212 can be implemented during a prediction phase of process 100 (e.g. step 106). In some examples, processes 100 and 200 can use the following logistic regression equations. It is noted that the data dictionaries of FIGS. 5-7 (infra) provide definitions of example variables. sl_yn_nm is the response variable. Response variable sl_yn_nm=1 if the residential home (or other real-estate entity) was listed or sold in the period of time. Otherwise, sl_yn_nm=0.

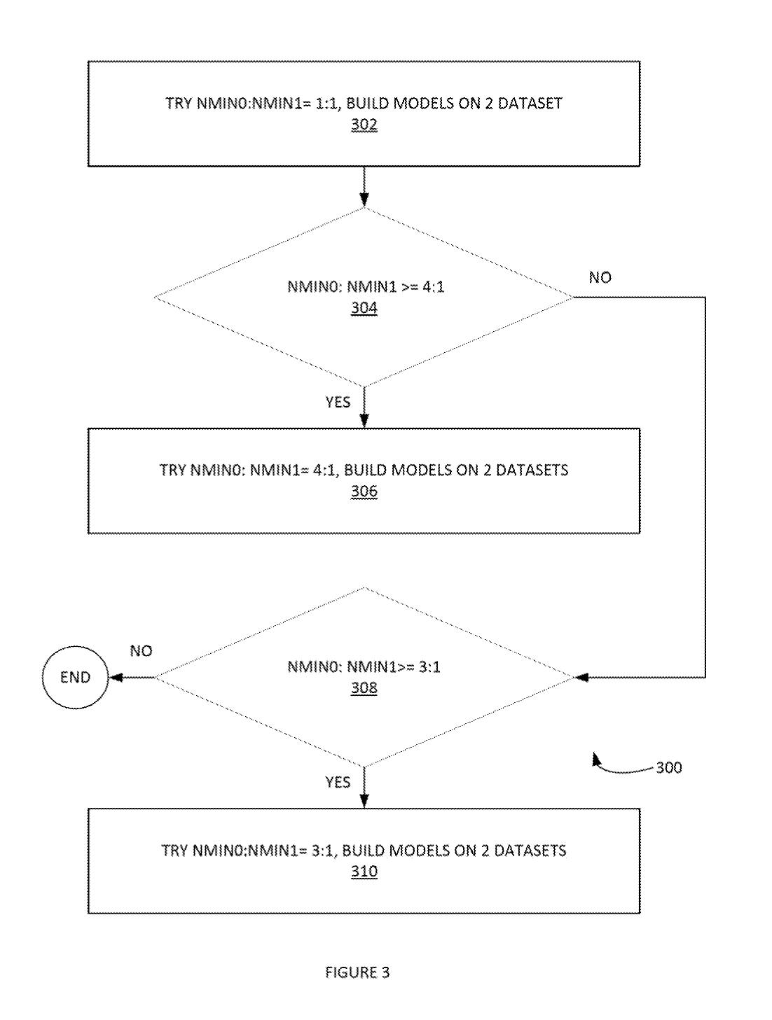

FIG. 3 illustrates an example process 300 adjusting a ratio of a dataset, according to some embodiments. For example, it can be assumed nmin0=sum(TrainData$sl_yn_nm==0), and nmin1=sum(TrainData$sl_yn_nm==1). In step 302, try nmin0:nmin1=1:1 and the models on two datasets can be built. In step 304, it can be determined if (nmin0: nmin1>=4:1). If ‘yes’, then process 300 can try nmin0: nmin1=4:1 as the ratio and the models on the two datasets can be built. If ‘no’, then process 300 can proceed to step 306. In step 306, it can be determined if (nmin0: nmin1>=3:1). If ‘yes’, then process 300 can try nmin0:nmin1=3:1 as the ratio and the models on the two datasets can be built. These two models can then be used as the default m=sqft(#features), and mtry=200. The built models can be applied on the test data set. The best BacktestIM can be selected. The corresponding champion model can be selected from the balanced random forest.

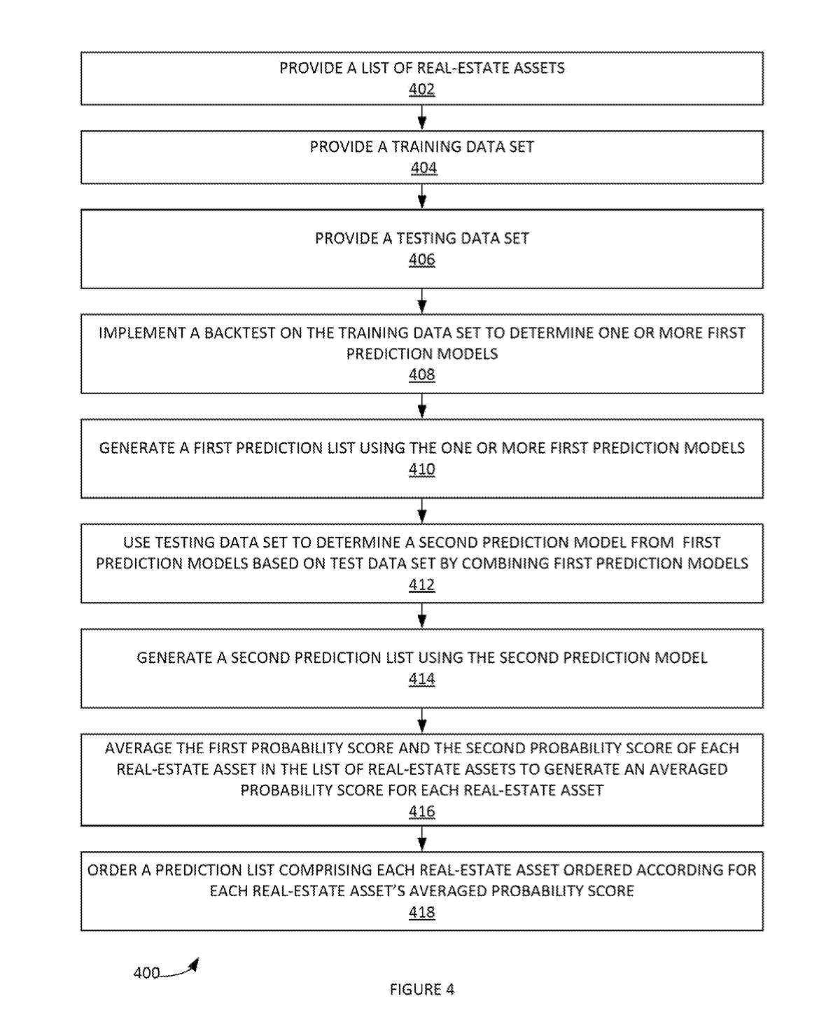

FIG. 4 illustrates a process 400 for implementing various embodiments herein, according to some embodiments. In step 402, process 400 can provide a list of real-estate assets, wherein each real-estate asset is associated with one or more real-estate assets attributes. In step 404, process 400 can provide a training data set wherein the training data set comprises a past population of data associated with a plurality of real-estate assets and a set of training-data set attributes for each real-estate asset in the plurality of real-estate assets. In step 406, process 400 can provide a testing data set wherein the testing data set comprises another past population of data associated with the plurality of real-estate assets and a set testing-data set attributes for each real-estate asset in the plurality of real-estate assets, wherein the set of testing data set attributes comprises an updated version of the training data set attributes from a specified later time. In step 408, process 400 can implement a backtest on the training data set to determine one or more first prediction models. In step 410, process 400 can generate a first prediction list using the one or more first prediction models, wherein a first probability score for each real-estate asset in the list of real-estate assets to be placed for sale within a specified period of time is calculated using the one or more first prediction models. In step 412, process 400 can use the testing data set to determine a second prediction model from the one or more first prediction models based on the test data set by combining the one or more first prediction models. In step 414, process 400 can generate a second prediction list using the second prediction model, wherein a second probability score for each real-estate asset in the list of real-estate assets to be placed for sale within the specified period of time is calculated using the second prediction model. In step 416, process 400 can average the first probability score and the second probability score of each real-estate asset in the list of real-estate assets to generate an averaged probability score for each real-estate asset. In step 418, process 400 can order a prediction list comprising each real-estate asset ordered according for each real-estate asset's averaged probability score.

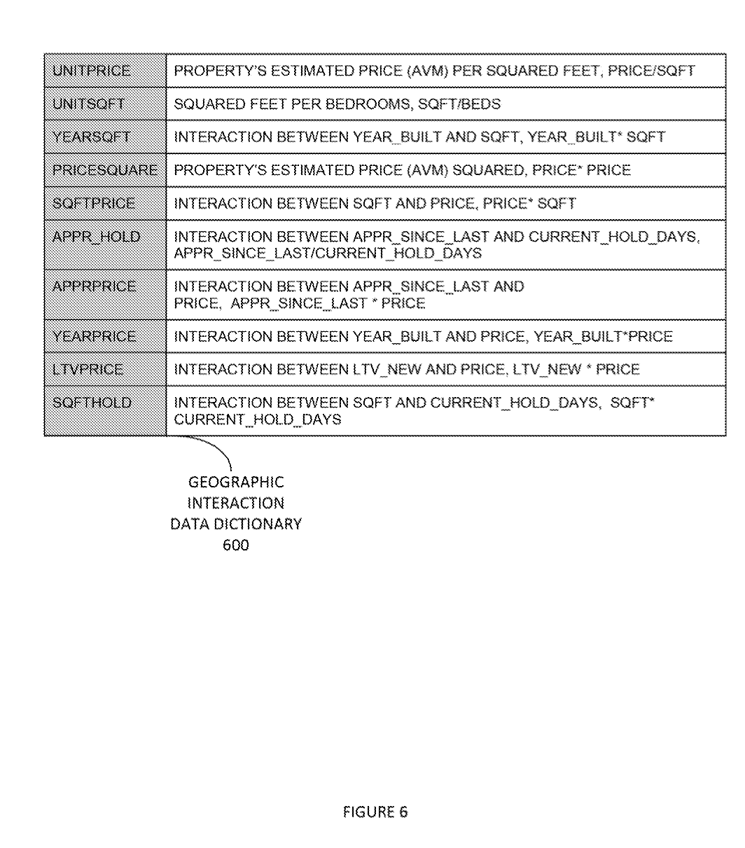

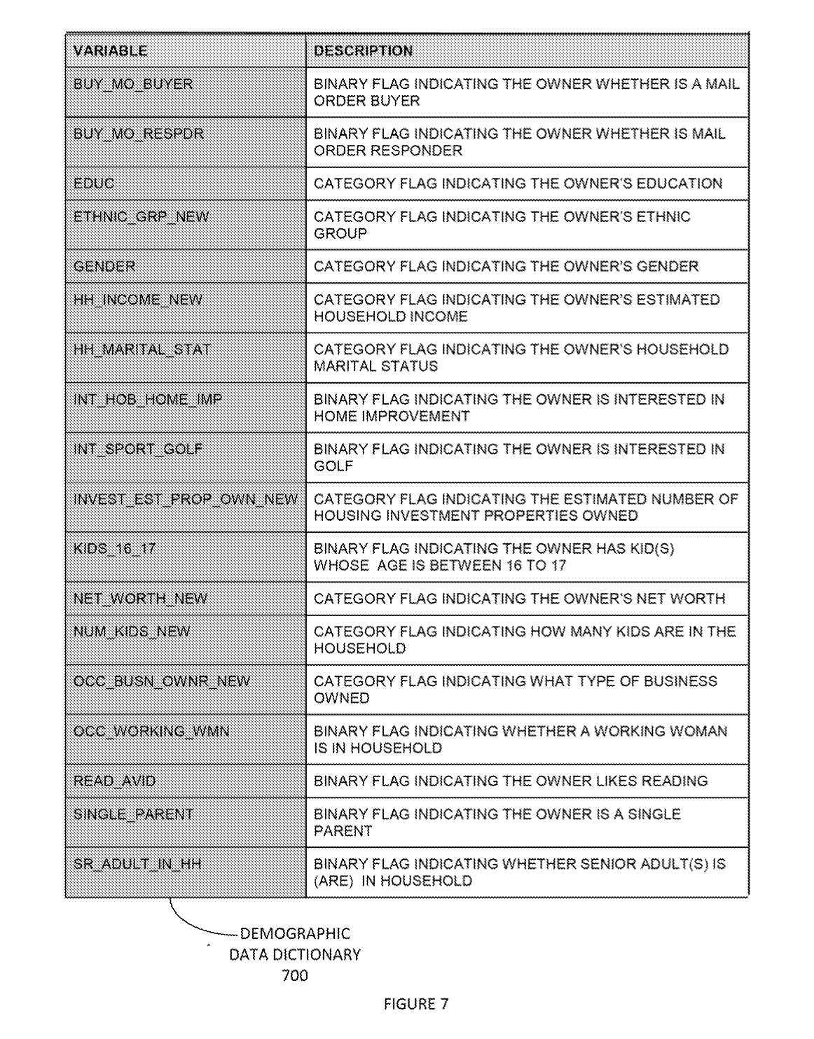

FIGS. 5-7 illustrate example data dictionaries, according to some embodiments. More specifically, FIG. 5 illustrates an example geographic data dictionary 500. FIG. 6 illustrates an example geographic interaction data dictionary 600. FIG. 7 illustrates an example demographic data dictionary 700.

Example ensemble method(s) are now provided. In statistics and machine learning, ensemble methods can be used multiple learning algorithms to obtain better predictive performance than could be obtained from any of the constituent learning algorithms. In one example, during processes 100 and/or 200, four champion models can be generated. Two champion models can be built using logistic regression methods. One champion model can be built using regular random forest. One champion model can be built using balanced random forest. These various champion models can be ensembled together to deliver a single champion result. Random forest can utilize nonlinear regression, whereas logistic regression can be a typical linear regression. Logistic regressions can be used to determine broad relationships between independent variables and predicted classes. Random forests are good at finding these narrower signals, but they can be overconfident and overfit noisy regions in the input space. Accordingly, in some examples, ensemble learning, combining nonlinear with linear, can have more power to capture data feature and provide a better prediction accuracy. In some examples, a loop can be provided to assign a specified weight on each model. Models can be combined using conditional probabilities on permutations, using a purely Bayesian methodology and/or using cross-validation, etc. A weight loop can be applied on testing data to search for the optimal combination of different models. The weights can be selected based on the best BacktestIM. Thus, different tracts (and/or other geographic region types) can have different weights on models.

It is noted that a cap can be provided for the BacktestIM value. A capped can be determined as follows: BacktestIM=BacktestIM, if BacktestIM<=2; capped BacktestIM=1+BacktestIM*0.5, if BacktestIM>2.

An example of an F-Score Backtest is now provided. An F-Score backtest can be used to determine the most efficient percentage (e.g. top 20 or top 30, etc.) of properties that are delivered to a client. A nationwide F-Score can be calculated. An F-score can consider both the precision ‘p’ and the recall ‘r’ of a test to compute the score. Precision can be how many of the prioritized residential-home list are actually sl_yn_nm=1. Recall can be how many of sl_yn_n=1 does the prioritized residential-home list contain. Accordingly, the following equation can be used: F-Score (harmonic average of precision and recall)=2*(Precision*Recall)/(Precision+Recall). The higher F-Score, the better to deliver a prioritized residential-home list based on that corresponding threshold. A threshold range can be provided. In one example, the threshold range can be from 0 to 1 with increment increases of 0.05. When a probability>=the threshold, a conclusion can be provided that the residential home is in delivered list. When the threshold=0, this means that all properties can be delivered. The recall can be equal to one (1) but precision can be a small number.

In one example, for business usage, the F-Score searching strategy can be modified. The F-Score can be calculated from the top five percent (5%) to top fifty percent (50%), every time increases five percent (5%). It is noted that in yet another example a top twenty percent (20%) can be utilized. To classify a new object from an input vector, the input vector is placed in each of the trees in the forest. A random forest can be used as a regression. The forest take the average votes over all the tress in the forest. Each tree provides a classification, and each tree votes for that class. The forest chooses the classification having the most votes (e.g. over all the trees in the forest). When the training set for the current tree is drawn by sampling with replacement, about one-third of the cases are left out of the sample. This OOB (out-of-bag) data can be used to obtain a running unbiased estimate of the classification error as trees are added to the forest. It can also be used to get estimates of variable importance.

An example of an implementation of a balanced random forest is now provided. With imbalanced data a classifier that is built using all of the data may have a tendency to ignore a minority class. Accordingly, an ensemble classifier can be constructed on the basis of a large number of relatively small and balanced subsets, where representatives from both patterns are be selected randomly. Various methods can be applied to this scenario, including, inter alia: algorithm specific approach; post-processing for the learned model; and/or pre-processing for the data (e.g. under-, over-, progressive, active). Additionally, two methods can be used to handle imbalanced classification through random forest: balanced random forest and weighted random forest. For cost sensitive learning examples, a high cost can be assigned to misclassification to minority (e.g. using weighted random forest). For sampling techniques, a balanced random forest can be used for down-sampling the majority class or over-sampling the minority.

When there is significant probability that bootstrap sample contains few to none of a set of minority classes then balanced random forest can be used. Artificially making class prior equal either by down-sampling the majority class or over-sampling the minority class is can be implemented in some examples. For balanced random forest, the following steps can be performed. For each iteration, a bootstrap sample can be drawn from a minority class. The same number of cases can be drawn with replacement from the majority classes. The normal random forest can be performed.

Three types of balanced random forest can be implemented in some examples. Downsampling can be implemented. In downsampling, the majority class can be sampled to make its frequency closer to the rarest class. In upsampling, the minority class can be resampled to increase the corresponding frequencies. In a hybrid approach, some methodologies use some upsampling and downsampling. Hybrid approaches can impute synthetic data for the minority class. One such example is the SMOTE (Synthetic Minority Over-sampling Technique) procedure. In some examples, processes 100 and 200 can implement downsampling.

Exemplary variable selection methods are now provided. Variable selection can be computed from permuting OOB data. The increase in mean of the error of a tree (e.g. MSE for regression and misclassification rate for classification) can be used as the score for selecting variables that are randomly permuted in the OOB samples. The calculation can be influenced by two major factors: high dimensionality and/or the presence of groups of highly correlated predictors.

Two example methods can be applied to variable selection. A first method can be recursive elimination of variables. A second method can be a combination of ascendant strategy based on a sequential introduction of variables and stepwise ascending variable introduction strategy. Both of these can be used to implement variable selection. In one example, the OOB error can be used to measure a model's performance. The default parameters can be mtry=sqrt(feature size) and/or ntree=2000. ‘mtry’ can signify the number of that were randomly selected to build each tree. ‘ntree’ can be the size of forest.

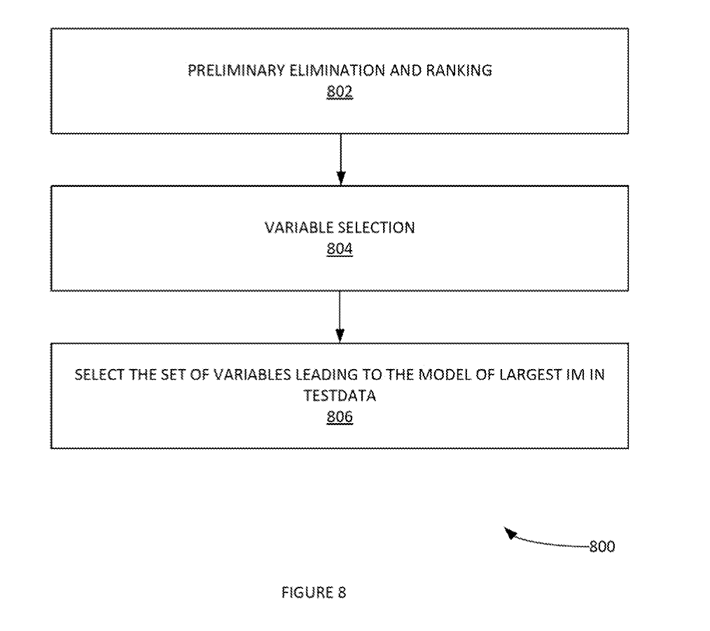

FIG. 8 illustrates an example process of combination of ascendant strategy based on a sequential introduction of variables and stepwise ascending variable introduction strategy variable selection, according to some embodiments. In step 802, preliminary elimination and ranking operations are performed. For example, process 800 can run random forest for ‘n’ times (e.g. fifty (50) times). Process 800 can compute the random forest scores of variables importance (e.g. averaged from the fifty (50) runs). Process 800 can then sort the variables in descending order. Process 800 can cancel the variables of small importance. The threshold can be determined by considering variable importance and standard deviation of importance. Process 800 can order the ‘m’ remaining variables in decreasing order of importance.

In step 804, variable selection operations can be performed. For modelling: construct the nested collection of random forest models involving the k first variables, for k=1 to m, by step of 1. In every iteration, process 800 can invoke a backtesting procedure. For example, process 800 can calculate the IM (e.g. IM=BacktestIM) in test data, a variable is added when the testIM increases by 0.05. In step 806, process 800 can select the set of variables leading to the model of largest IM in test data.

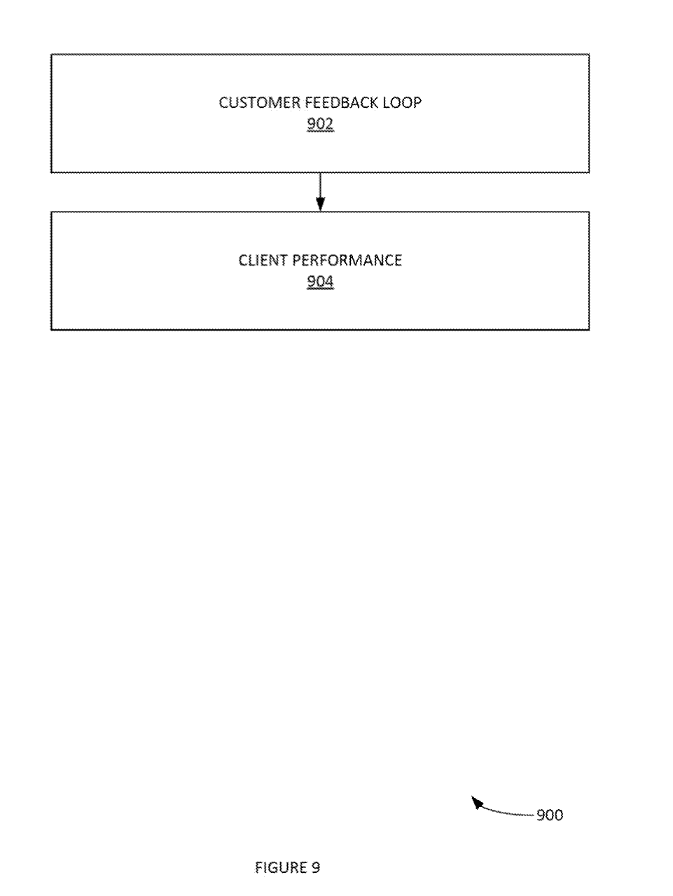

FIG. 9 illustrates an example process 900 improving a prioritized a list of real-estate assets, according to some embodiments. In step 902, a customer feedback loop can be applied. The customer feedback loop include, inter alia, the following aspects: property data, demographic data, social-media data and/or other solutions. In one example, a customer can report an issue with a real-estate asset. For example, a customer can log into a website or user an application to correct real-estate asset attributes (e.g. change the year built of their house to 1990 from 1995). In another example, a customer can provide/update relevant demographic information (e.g. their income level). In yet another example, a customer can claim that their real-estate asset is ten percent (10%) higher than an entity's estimation. In another example, the customer can indicate he/she doesn't plan to sell the property for a specific period of time (e.g. next two (2) years).

In one example, a real-estate entity owner's social media data (e.g. Facebook®, Twitter®, LinkedIn®, etc.) can be searched for indicators that the user intends to place his/her real-estate asset for sale. For example, these indicators can be used as attributes in processes 100 and/or 200 supra. For example, LinkedIn® data can be used to determine that a home owner has taken a new job in another city. This can indicate that the home owner may place her current home for sale in the next six months. In another example, a home owner can change his status from married to single signaling a divorce. The divorce status can be used as an indicator that the user may put his home up for sale at some point in the future.

In step 904, a client prediction performance can be calculated for the territories after the client started a SmartTargeting program. The prediction performance can be a number between 0 and infinity. This value can compare the sold or listed rate between the top 20% list and bottom 80%, showing how effective the top 20% list is. For example, territory A has 1500 properties. There were 60 events (listed or sold) happened after the client purchased the territory, 20 of them were on the SmartTargeting top 20% list. The number of homes on top 20%=1500*20%=300. The number of homes on bottom 800% 1500*80%=1200. The number of events on top 20%=20. The number of events on bottom 80%=60−20=40. The prediction performance=(sold or listed rate on top 20%)/(sold or listed rate on bottom 80%)=(20/300)/(40/1200)=20*4/40=2.0× (more effective). The TrainData/TestData/PredData can be updated every three months. Upon the updating of the data, the model can be rerun and the top 20% list for each territories can be regenerated to ensure the latest information is being delivered.

Exemplary Environment and Architecture

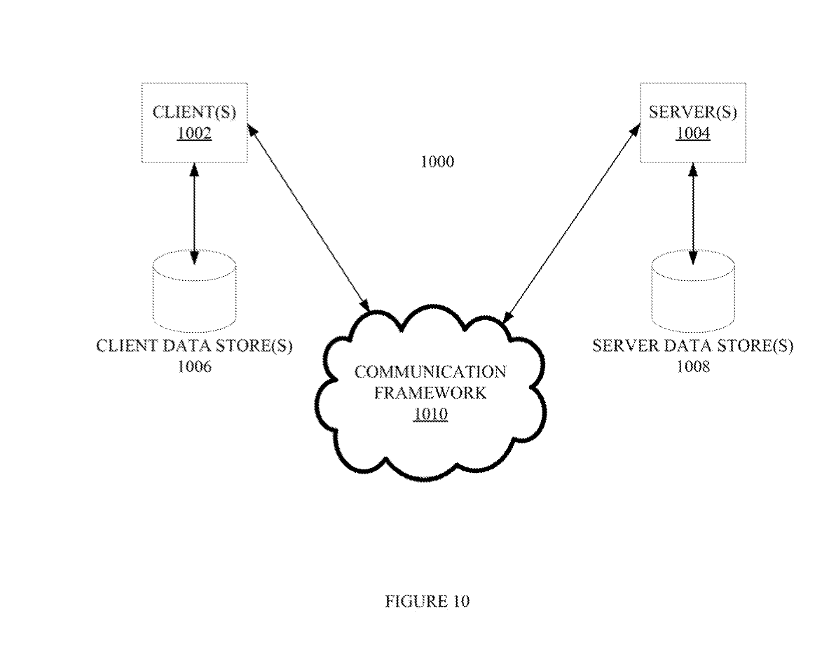

FIG. 10 is a block diagram of a sample computing environment 1000 that can be utilized to implement some embodiments. The system 1000 further illustrates a system that includes one or more client(s) 1002. The client(s) 1002 can be hardware and/or software (e.g., threads, processes, computing devices). The system 1000 also includes one or more server(s) 1004. The server(s) 1004 can also be hardware and/or software (e.g., threads, processes, computing devices). One possible communication between a client 1002 and a server 1004 may be in the form of a data packet adapted to be transmitted between two or more computer processes. The system 1000 includes a communication framework 1010 that can be employed to facilitate communications between the client(s) 1002 and the server(s) 1004. The client(s) 1002 are connected to one or more client data store(s) 1006 that can be employed to store information local to the client(s) 1002. Similarly, the server(s) 1004 are connected to one or more server data store(s) 1008 that can be employed to store information local to the server(s) 1004. In some embodiments, server(s) 1004 and/or data store(s) 1008 implemented in a cloud computing environment.

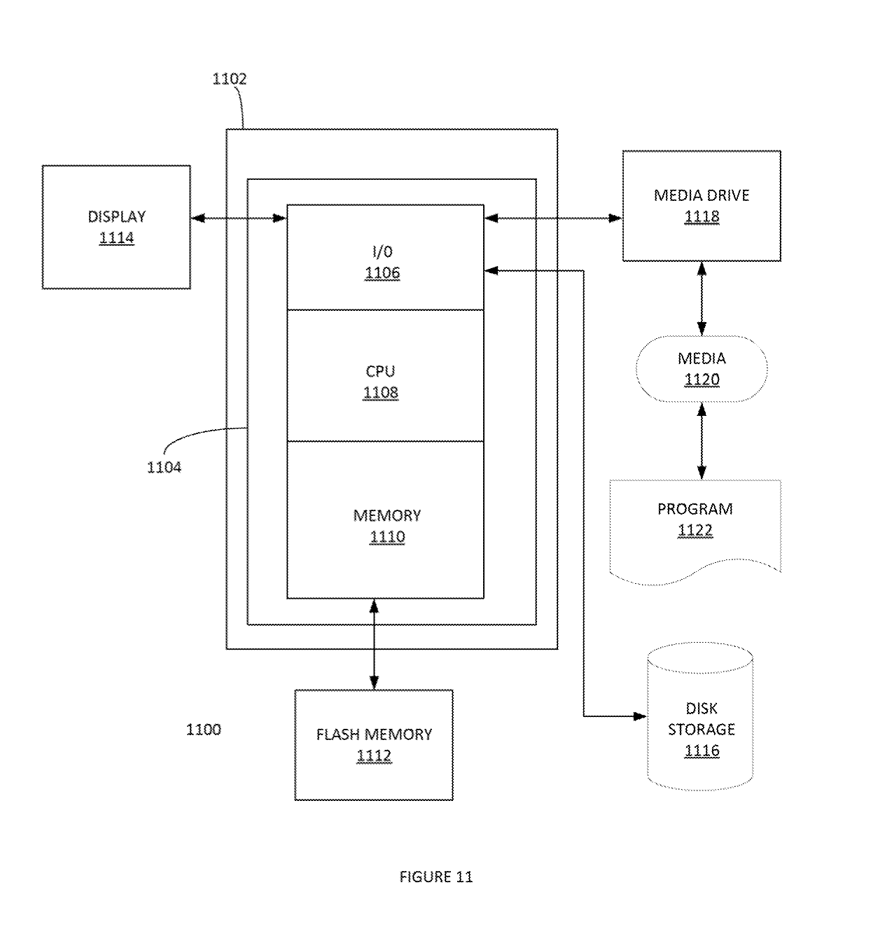

FIG. 11 depicts an exemplary computing system 1100 that can be configured to perform any one of the processes provided herein. In this context, computing system 1100 may include, for example, a processor, memory, storage, and I/O devices (e.g., monitor, keyboard, disk drive, Internet connection, etc.). However, computing system 1100 may include circuitry or other specialized hardware for carrying out some or all aspects of the processes. In some operational settings, computing system 1100 may be configured as a system that includes one or more units, each of which is configured to carry out some aspects of the processes either in software, hardware, or some combination thereof.

FIG. 11 depicts computing system 1100 with a number of components that may be used to perform any of the processes described herein. The main system 1102 includes a motherboard 1104 having an I/O section 1106, one or more central processing units (CPU) 1108, and a memory section 1110, which may have a flash memory card 1112 related to it. The I/O section 1106 can be connected to a display 1114, a keyboard and/or other user input (not shown), a disk storage unit 1116, and a media drive unit 1118. The media drive unit 1118 can read/write a computer-readable medium 1120, which can contain programs 1122 and/or data. Computing system 1100 can include a web browser. Moreover, it is noted that computing system 1100 can be configured to include additional systems in order to fulfill various functionalities. In another example, computing system 1100 can be configured as a mobile device and include such systems as may be typically included in a mobile device such as GPS systems, gyroscope, accelerometers, cameras, augmented-reality systems, etc.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it will be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed as new and desired to be protected by Letters Patent of the United States is:

1. A method of generating a prediction list of real-estate assets that have a specified probability of being placed for sale within a specified period of time comprising:
providing a list of real-estate assets, wherein each real-estate asset is associated with one or more real-estate assets attributes;
providing a training data set wherein the training data set comprises a past population of data associated with a plurality of real-estate assets and a set of training-data set attributes for each real-estate asset in the plurality of real-estate assets;
providing a testing data set wherein the testing data set comprises another past population of data associated with the plurality of real-estate assets and a set testing-data set attributes for each real-estate asset in the plurality of real-estate assets, wherein the set of testing data set attributes comprises an updated version of the training data set attributes from a specified later time;
implementing a backtest on the training data set to determine one or more first prediction models;
generating a first prediction list using the one or more first prediction models, wherein a first probability score for each real-estate asset in the list of real-estate assets to be placed for sale within a specified period of time is calculated using the one or more first prediction models;
using the testing data set to determine a second prediction model from the one or more first prediction models based on the test data set by combining the one or more first prediction models;
generating a second prediction list using the second prediction model, wherein a second probability score for each real-estate asset in the list of real-estate assets to be placed for sale within the specified period of time is calculated using the second prediction model;
averaging the first probability score and the second probability score of each real-estate asset in the list of real-estate assets to generate an averaged probability score for each real-estate asset; and
ordering a prediction list comprising each real-estate asset ordered according for each real-estate asset's averaged probability score.

2. The method of claim 1, wherein a real-estate assets comprises a residential real-estate home.

3. The method of claim 1, wherein the one or more first prediction models comprise two champion logistic-properties prediction models.

4. The method of claim 3, wherein the one or more first prediction models comprise a balanced-random-forest model.

5. The method of claim 4, wherein the one or more first prediction models comprises an unbalanced-random-forest prediction model.

6. The method of claim 5, wherein the testing data set is used to tune the weights of the one or more first prediction models.

7. The method of claim 1, wherein the training data set comprises a two-years previous past population of data.

8. The method of claim 1, wherein the testing data set comprises a one-year previous past population of data.

9. A computerized system generating a prediction list of real-estate assets that have a specified probability of being placed for sale within a specified period of time comprising:
a processor configured to execute instructions;
a memory containing instructions when executed on the processor, causes the processor to perform operations that:
provide a list of real-estate assets, wherein each real-estate asset is associated with one or more real-estate assets attributes;
provide a training data set wherein the training data set comprises a past population of data associated with a plurality of real-estate assets and a set of training-data set attributes for each real-estate asset in the plurality of real-estate assets;
provide a testing data set wherein the testing data set comprises another past population of data associated with the plurality of real-estate assets and a set testing-data set attributes for each real-estate asset in the plurality of real-estate assets, wherein the set of testing data set attributes comprises an updated version of the training data set attributes from a specified later time;
implement a backtest on the training data set to determine one or more first prediction models;
generate a first prediction list using the one or more first prediction models, wherein a first probability score for each real-estate asset in the list of real-estate assets to be placed for sale within a specified period of time is calculated using the one or more first prediction models;
use the testing data set to determine a second prediction model from the one or more first prediction models based on the test data set by combining the one or more first prediction models;
generate a second prediction list using the second prediction model, wherein a second probability score for each real-estate asset in the list of real-estate assets to be placed for sale within the specified period of time is calculated using the second prediction model;
average the first probability score and the second probability score of each real-estate asset in the list of real-estate assets to generate an averaged probability score for each real-estate asset; and
order a prediction list comprising each real-estate asset ordered according for each real-estate asset's averaged probability score.

10. The computerized system of claim 9, wherein a real-estate assets comprises a residential real-estate home.

11. The computerized system of claim 10, wherein the one or more first prediction models comprise two champion logistic-properties prediction models.

12. The computerized system of claim 11, wherein the one or more first prediction models comprise a balanced-random-forest model.

13. The computerized system of claim 12, wherein the one or more first prediction models comprises an unbalanced-random-forest prediction model.

14. The computerized system of claim 13, wherein the testing data set is used to tune the weights of the one or more first prediction models.

15. The computerized system of claim 14, wherein the training data set comprises a two-years previous past population of data.

16. The computerized system of claim 15, wherein the testing data set comprises a one-year previous past population of data.
